(19) United States
(12) Patent Application Publication
(10) Pub. No.: US 2025/0282278 A1
(43) Pub. Date: Sep. 11, 2025

(54) AUTONOMOUS TRANSPORT VEHICLE

(71) Applicant: DENSO CORPORATION, Kariya-city (JP)

(72) Inventor: AKIHIKO MORIYA, Kariya-city (JP)

(21) Appl. No.: 19/214,858

(22) Filed: May 21, 2025

Related U.S. Application Data
(63) Continuation of application No. PCT/JP2023/040456, filed on Nov. 9, 2023.

(30) Foreign Application Priority Data
Nov. 25, 2022 (JP) 2022-188619

(51) Int. Cl. B60P 7/06

(52) U.S. Cl. CPC B60P 7/065

(57) ABSTRACT

An autonomous transport vehicle configured to transport a package includes a housing, a cushion, and a compressor. The housing has an inner wall that defines a compartment in which the package is housed. The cushion has at least two fixed portions in a reference direction and fixed to the inner wall in the compartment at the at least two fixed portions. The cushion includes multiple bags between the two fixed portions in the reference direction. Each of the multiple bags is configured to inflate from the inner wall with gas. The compressor is configured to inject the gas into the multiple bags and draw the gas from the bags.

### CROSS REFERENCE TO RELATED APPLICATIONS

The present application is a continuation application of International Patent Application No. PCT/JP2023/040456 filed on Nov. 9, 2023, which designated the U.S. and claims the benefit of priority from Japanese Patent Application No. 2022-188619 filed on Nov. 25, 2022. The entire disclosures of all the above applications are incorporated herein by reference.

### TECHNICAL FIELD

The present disclosure relates to an autonomous transport vehicle configured to transport a package.

### BACKGROUND

There is a box for housing a package, which includes air cushions and an air compressor for filling the air cushions with air.

### SUMMARY

A first aspect of the present disclosure is an autonomous transport vehicle configured to transport a package. The autonomous transport vehicle includes a housing, a cushion and a compressor. The housing has an inner wall that defines a compartment in which the package is housed. The cushion may have at least two fixed portions in a reference direction and may be fixed to the inner wall in the compartment at the at least two fixed portions. The cushion may have multiple bags between the at least two fixed portions in the reference direction. Each of the multiple bags is configured to inflate from the inner wall with gas. The compressor is configured to inject the gas into the multiple bags and draw the gas from the bags.

A second aspect of the present disclosure is an autonomous transport vehicle configured to transport a package. The autonomous transport vehicle includes a housing, a cushion and a compressor. The housing has an inner wall that defines a compartment in which the package is housed. The cushion is fixed to the inner wall, and may include a bag and an elastic portion. The bag is configured to inflate with gas from the inner wall, and has a tip end. The elastic portion may be disposed at the tip end of the bag. The compressor is configured to inject the gas into the compartment and draw the gas from the compartment.

### BRIEF DESCRIPTION OF THE DRAWINGS

FIG. 1 is a schematic diagram showing the overall configuration of an autonomous transport vehicle according to a first embodiment.

FIG. 2 is a partial cross-sectional view mainly showing the configuration of a housing in the autonomous transport vehicle of the first embodiment.

FIG. 3 is a partial cross-sectional view showing an open state in which a rear wall portion is open in the autonomous transport vehicle of the first embodiment.

FIG. 4 is a partial cross-sectional view mainly showing the configuration of the housing in the autonomous transport vehicle of the first embodiment.

FIG. 5 is a schematic diagram showing an attachment configuration of a cushion.

FIG. 6 is a perspective view showing bags and elastic portions of the cushion.

FIG. 7 is a block diagram showing the functional configuration of a controller.

FIG. 8 is a flowchart showing a control flow according to the first embodiment.

FIG. 9 is a flowchart showing the control flow according to the first embodiment.

FIG. 10 is a flowchart showing a control flow according to a second embodiment.

FIG. 11 is a partial cross-sectional view mainly showing the configuration of a housing of an autonomous transport vehicle according to a third embodiment.

FIG. 12 is a partial cross-sectional view mainly showing the configuration of the housing in a contracted state of the autonomous transport vehicle according to the third embodiment.

FIG. 13 is a schematic diagram showing an attachment configuration of a cushion of the autonomous transport vehicle according to the third embodiment.

FIG. 14 is a partial cross-sectional view mainly showing the configuration of a housing of an autonomous transport vehicle according to a fourth embodiment.

### DESCRIPTION OF EMBODIMENTS

To begin with, examples of relevant techniques will be described.

There is a box for housing a package, which includes air cushions and an air compressor for filling the air cushions with air. The air cushions are arranged on the two opposing inner side surfaces of the box. When air is injected into the air cushions by the air compressor, the air cushions inflate into a space between the box and the package.

It is necessary to ensure the pressure of the filled air in the air cushions to secure the package. However, each of the air cushions in the box described above has a single bag between the fixed portions at the side surface, and the single bag inflate when the air cushion is filled with air. When the air pressure of such air cushion is relatively high, the contact area between the package and the sharpened tip end of the air cushion may become small. This may result in insufficient securing of the package, causing the package to move due to swaying during transportation.

The present disclosure provides an autonomous transport vehicle configured to secure a package.

Hereinafter, a technical solution of the present disclosure to address the above-described objectives will be described.

A first aspect of the present disclosure is an autonomous transport vehicle configured to transport a package. The autonomous transport vehicle includes a housing, a cushion and a compressor. The housing has an inner wall that defines a compartment in which the package is housed. The cushion has at least two fixed portions in a reference direction and fixed to the inner wall in the compartment at the at least two fixed portions. The cushion has multiple bags between the at least two fixed portions in the reference direction. Each of the multiple bags is configured to inflate from the inner wall with gas. The compressor is configured to inject the gas into the multiple bags and draw the gas from the bags.

According to the first aspect, the multiple bags that are inflated by the compressor are positioned between the fixed portions. Thus, the multiple bags can come into contact with the package. Thus, the contact area between the cushion and the package can be relatively large. Thus, the package is properly secured.

A second aspect of the present disclosure is an autonomous transport vehicle configured to transport a package. The autonomous transport vehicle includes a housing, a cushion and a compressor. The housing has an inner wall that defines a compartment in which the package is housed. The cushion is fixed to the inner wall, and includes a bag and an elastic portion. The bag is configured to inflate with gas from the inner wall, and has a tip end. The elastic portion is disposed at the tip end of the bag. The compressor is configured to inject the gas into the compartment and draw the gas from the compartment.

According to the second aspect, the elastic portion at the tip end of the bag, which is inflated by the compressor, increases the contact area between the cushion and the package. The elasticity of the elastic portion can press the package against the inner wall on the opposite side in the inflating direction. Thus, the package is properly secured.

The following will describe embodiments of the present disclosure with reference to the drawings. Elements corresponding to each other among the embodiments are assigned the same numeral and their descriptions may be omitted. When only a part of a component is described in an embodiment, the other part of the component can be relied on the component of the preceding embodiment. Furthermore, in addition to the combination of components explicitly described in each embodiment, it is also possible to combine components from different embodiments, as long as the combination does not cause any difficulty, even if it is not explicitly described.

### First Embodiment

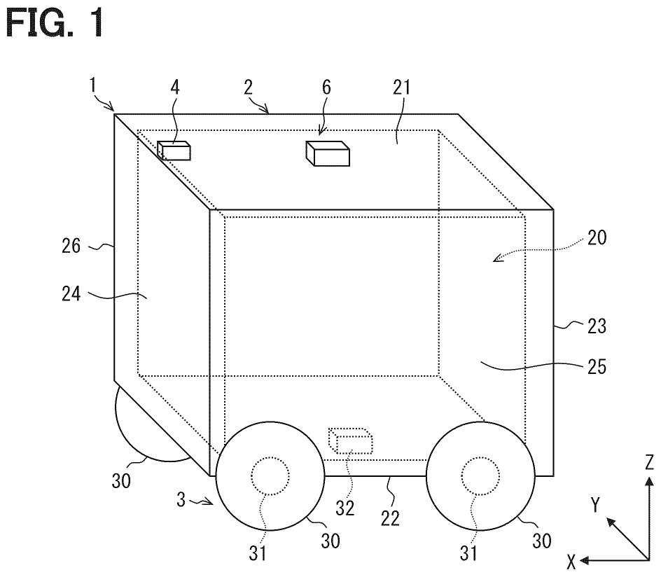

An autonomous transport vehicle 1 according to the first embodiment shown in FIG. 1 transports a package P by autonomous driving. The autonomous transport vehicle 1 autonomously travels in any direction such as front, back, left, or right directions. The autonomous transport vehicle 1 may be a delivery vehicle that autonomously travels on a road and transports packages P to the delivery destination. The autonomous transport vehicle 1 may be a logistics vehicle that autonomously travels through a warehouse to transport packages P. The autonomous transport vehicle 1 may be another vehicle having the function of transporting a package P. Furthermore, the autonomous transport vehicle 1 may receive remote driving assistance or driving control through communication with an external center. In the following description, the front-rear direction of the autonomous transport vehicle 1 is referred to as the X direction, the left-right direction as the Y direction, and the up-down direction as the Z direction.

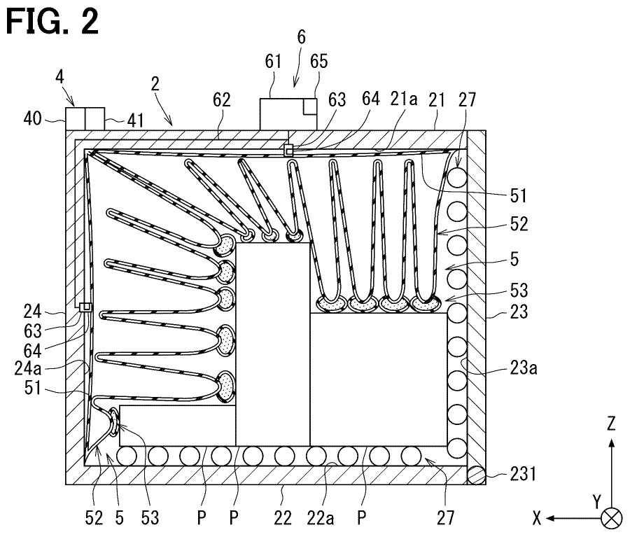

The autonomous transport vehicle 1 includes a housing 2, a drive system 3, a sensor system 4, a cushion 5, and a compressor unit 6. The cushion 5 is not shown in FIG. 1. The drive system 3 is not shown in FIGS. 2 to 4. The housing 2 forms the body of the autonomous transport vehicle 1 which is driven by the drive system 3 based on sensor information from the sensor system 4.

The drive system 3 includes drive wheels 30, drive actuators 31, and a battery 32. The drive wheels 30 are supported by the housing 2. Each of the drive wheels 30 is rotatable independently. The drive wheels 30 may be Mecanum wheels or Omni wheels, which are capable of turning due to the difference in rotational speed between the drive wheels 30. In addition to the drive wheels 30, driven wheels may be provided.

The drive actuators 31 are mounted in the housing 2. Each of the drive actuators 31 is mainly composed of an individual electric motor. Each of the drive actuators 31 rotates the corresponding drive wheel 30 independently. Each of the drive actuator 31 may include a brake unit that applies braking to the corresponding drive wheel 30 during rotation. Each of the drive actuator 31 may include a lock unit that locks the corresponding drive wheel 30 while stopped.

The battery 32 is mounted, for example, on the lower part of the housing 2. The battery 32 is mainly composed of a storage battery such as a lithium-ion battery, for example. The battery 32 stores electric power by charging from an external device, and supplies the electric power to electric components in the autonomous transport vehicle 1 by discharging. The battery 32 may store regenerated electric power from the drive actuators 31. The battery 32 is connected to the drive actuators 31, the sensor system 4, and the controller 65 via a wire harness or the like to be able to supply power thereto.

The sensor system 4 acquires sensing information usable by the autonomous transport vehicle 1 by sensing the external environment and the internal environment of the autonomous transport vehicle 1. For this purpose, the components of the sensor system 4 are mounted on the housing 2. Specifically, the sensor system 4 includes an external sensor 40 and an internal sensor 41.

The external sensor 40 acquires external environment information as sensing information from the external environment that is the surrounding environment of the autonomous transport vehicle 1. The external sensor 40 of a object detection type acquires the external information by detecting an object existing in the external environment of the autonomous transport vehicle 1. Such external sensor 40 may be at least one of a camera, a Light Detection and Ranging/Laser Imaging Detection and Ranging (LiDAR), a radar, and sonar.

The external sensor 40 of a positioning type may acquire external environment information by receiving positioning signals from artificial satellites of Global Navigation Satellite System (i.e., GNSS) existing in the external environment of the autonomous transport vehicle 1. Such external sensor 40 may be a GNSS receiver. The external sensor 40 of a communication type may acquire external environment information by transmitting and receiving a communication signal to and from a V2X system existing in the external environment of the autonomous transport vehicle 1. Such external sensor 40 may be at least one of a Dedicated Short Range Communications (i.e., DSRC) communication device, a cellular V2X (i.e., C-V2X) communication device, a Bluetooth (registered trademark) device, a Wi-Fi (registered trademark) device, and an infrared communication device. The external sensor 40 of the V2X type in particular may be capable of communicating with at least one of an external center or another autonomous transport vehicle.

The internal sensor 41 acquires the internal environment information as sensing information from the internal environment of the autonomous transport vehicle 1. The internal sensor 41 of a package detection type acquires the internal information by detecting a package P on the loading area in the compartment 20, which is the internal environment of the autonomous transport vehicle 1. Such internal sensor 41 may be at least one of a weight sensor, a pressure sensor, a camera, or a Radio Frequency Identifier (RFID) reader. The internal sensor 41 of a physical quantity detection type may acquire the internal information by detecting a specific physical quantity of motion inside the autonomous transport vehicle 1. Such internal sensor 41 may be at least one of a driving speed sensor, an acceleration sensor, and a yaw-rate sensor.

The housing 2 defines the compartment 20 and surrounds the compartment 20 from above, below, front, rear, left and right sides. The compartment 20 in the housing 2 has enough space to accommodate at least one package P.

The housing 2 is made of, for example, metal or resin and has a hollow shape. The housing 2 has an inner wall that defines the compartment 20 to house the package P. Specifically, the housing 2 has multiple wall portions 21, 22, 23, 24, 25 and 26 forming the inner wall, and elastic rollers 27.

The multiple wall portions 21, 22, 23, 24, 25, and 26 include an upper wall portion 21, a lower wall portion 22, a rear wall portion 23, a front wall portion 24, a left wall portion 25, and a right wall portion 26. These wall portions define the compartment 20 of the housing 2 in a substantially rectangular parallelepiped shape.

The upper wall portion 21 is located on the top side of the housing 2, and has an upper inner wall 21a that defines the upper surface of the compartment 20. The lower wall portion 22 is located on the lower side of the housing 2 to face the upper wall portion 21, and has a lower inner wall 22a that defines the lower surface of the compartment 20.

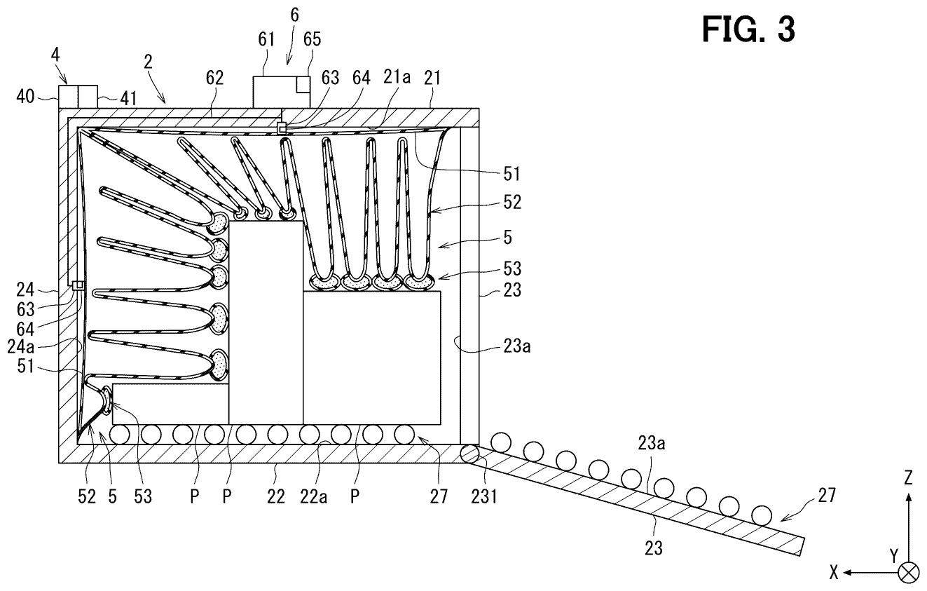

The rear wall portion 23 is one of four side walls of the housing 2, and located on the rear side in the front-rear direction of the autonomous transport vehicle 1. The rear wall portion 23 has a rear inner wall 23a that defines the rear surface of the compartment 20. As shown in FIG. 3, the housing 2 has an opening through which the package P is put into the compartment 20 and removed from the compartment 20. The rear wall portion 23 is configured as a door that closes and opens the opening of the housing 2. The rear inner wall 23a of the rear wall portion 23 is configured to face upward when the rear wall portion 23 is open. The rear inner wall 23a corresponds to a door inner wall. More specifically, for example, the rear wall portion 23 has a lower end portion 231 that is fixed to the lower wall portion 22, and the rear wall portion 23 is configured to pivot relative to the lower wall portion 22. The lower end portion 231 of the rear wall portion 23 may include a rotation shaft that is rotatably supported by the lower wall portion 22 and an actuator that is configured to rotate the rotation shaft. The actuator rotates the rotation shaft in response to instructions from the controller 65, which will be described below, thereby switching between a closed state in which the rear wall portion 23 closes the compartment 20 and the open state in which the rear wall portion 23 pivots about the lower end portion 231 to open the compartment 20. The rear wall portion 23 may have a locking mechanism for locking the rear wall portion 23 to at least one of the upper wall portion 21, the left wall portion 25 and the right wall portion 26. The rear wall portion 23 may be configured to be manually openable and closable.

The front wall portion 24 is one of the side walls of the housing 2, and located on the front side in the front-rear direction. The front wall portion 24 has a front inner wall 24a that defines the front surface of the compartment 20. The front inner wall 24a is an example of a door facing inner wall that faces the rear wall portion 23, which serves as a door. The left wall portion 25 is one of the four side walls of the housing 2, and located on the left side in the right-left direction. The left wall portion 25 has a left inner wall 25a that defines the left surface of the compartment 20. The left inner wall 25a serves as a side inner wall. The right wall portion 26 is one of the four side walls of the housing 2, and located on the right side in the right-left direction. The right wall portion 26 has a right inner wall 26a that defines the right surface of the compartment 20.

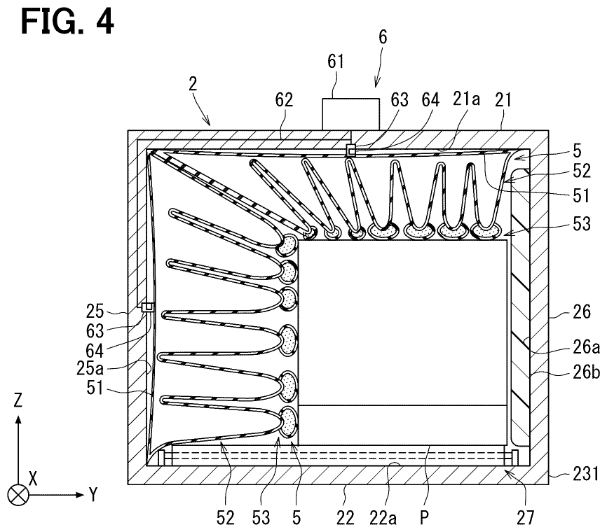

As shown in FIG. 4, the right inner wall 26a of the right wall portion 26 is provided with a shock absorbing member 26b. The shock absorbing member 26b is provided to cover most of the right inner wall 26a. The shock absorbing member 26b is made of an elastic material such as sponge or rubber. The inner wall on which the shock absorbing member 26b is disposed is an inner wall that faces a side inner wall on which a cushion 5, which will be described layer, is disposed.

The elastic rollers 27 allow the package P to move in and out of the compartment 20 by rotating. The elastic rollers 27 are provided, for example, on the lower inner wall 22a of the lower wall portion 22 and the rear inner wall 23a of the rear wall portion 23. Each of the elastic rollers 27 has a rotation shaft, an actuator, and an elastic cylindrical portion. The rotation shaft of each elastic roller 27 is rotatably supported by the lower wall portion 22 or the rear wall portion 23. The actuator rotates the rotation shaft in response to instructions from a control unit, which will be described later. The elastic cylindrical portion is a cylindrical body that covers the rotation shaft. The elastic cylindrical portion is formed from, for example, rubber or sponge.

The cushion 5 is formed in a hollow shape, and mainly made of a flexible sheet. The cushion 5 inflates when gas is injected into the hollow space therein. The gas may be air. The present embodiment includes multiple cushions 5, and the cushions 5 are provided on the upper inner wall 21a, the front inner wall 24a, and the left inner wall 25a, respectively.

Each of the cushions 5 has a bottom portion 51, multiple bags 52, and multiple elastic portions 53. The bottom portion 51 of the cushion 5 faces the inner wall. The bottom portion 51 has, for example, substantially the same shape and substantially the same size as the inner wall to which the bottom portion 51 is attached. That is, in this embodiment, the bottom portion 51 is formed in a rectangular shape. The bottom portion 51 defines a hole through which air is injected into and drew from by a compressor unit 6, which will be described later.

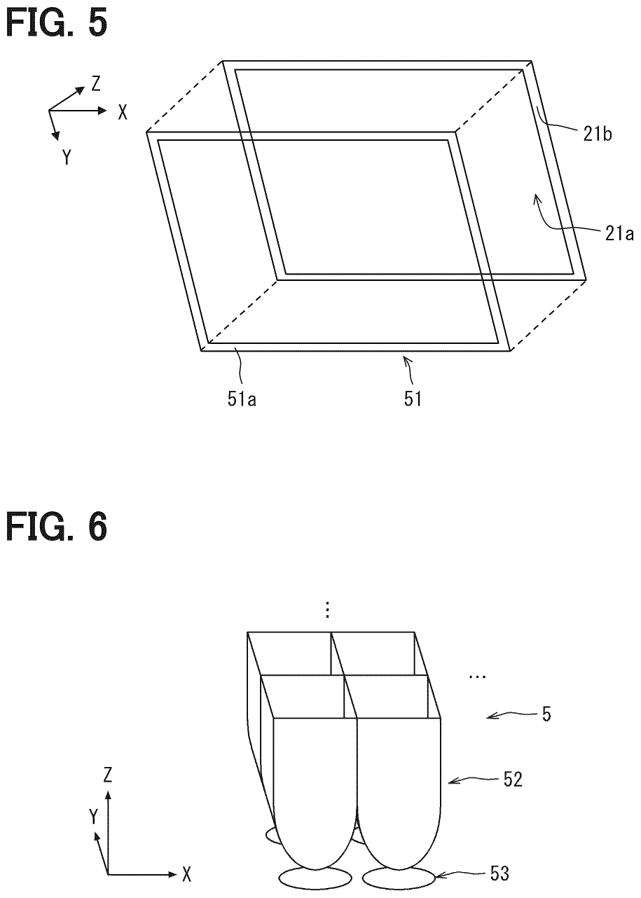

As shown in FIG. 5, the cushion 5 attached to the upper inner wall 21a has an attachment portion 51a at the bottom portion 51. The attachment portion 51a is fixed to an inner wall edge 21b of the upper inner wall 21a. Here, the attachment portion 51a is the outer edge portion of the bottom portion 51. The attachment portion 51a may be fixed to the upper inner wall 21a by an adhesive member such as an adhesive or an adhesive tape. Alternatively, the attachment portion 51a may be attached to the upper inner wall 21a through a frame, which is shaped to fit the inner wall edge 21b.

Since the bottom portion 51 is configured as described above, both ends of the bottom portion 51 in the X direction and the Y direction of the cushion 5 provided on the upper inner wall 21a are the attachment portion 51a that is fixed to the inner wall. That is, the ends in the X direction and the Y direction serve as the fixed portions. In this cushion 5, the X direction and the Y direction are “reference directions”. Similarly, for the cushion 5 attached to the front inner wall 24a, both ends of the bottom portion 51 in the Y direction and Z direction are the attachment portion 51a that is fixed to the front inner wall 24a, and the ends in the Y direction and Z direction serve as fixed portions. In this cushion 5, the Y direction and the Z direction are the “reference directions”. For the cushion 5 attached to the left inner wall 25a, both ends of the bottom portion 51 in the X direction and Z direction are the attachment portion 51a that is fixed to the left inner wall 25a, and the ends serve as fixed portions. In this cushion 5, the X direction and the Z direction are the “reference directions”.

Each of the cushions 5 has multiple bags 52 between the fixed portions (i.e., both fixed ends) in at least a specific direction. For example, in the cushion 5 provided on the upper inner wall 21a shown in FIG. 5, the multiple bags 52 are located between edges of the bottom portion 51 in the X direction and the Y direction. The proximal portion of each of the bags 52 is separated from the bottom portion 51, except at a position connected to the edge of the bottom portion 51. In other words, the internal spaces of the multiple bags 52 are fluidly connected to each other.

As shown in FIG. 6, the bags 52 inflate toward an inside of the compartment 20 when gas is injected into the bags 52 by the compressor unit 6, which will be described later. FIG. 6 shows the bags 52 and the elastic portions 53 of the cushion 5 on the upper inner wall 21a. In FIG. 6, the illustration of the bottom portion 51 is omitted, and only a part of the bags 52 and the elastic portions 53 are shown. The inflated bags 52 extend in the longitudinal direction (i.e., the vertical direction in FIG. 6) according to the internal pressure. The cross section of each inflated bag 52 perpendicular to the longitudinal direction has, for example, a rectangular frame shape. In other words, the shape of the inflated bag 52 viewed in the longitudinal direction is rectangular.

The elastic portions 53 are provided respectively at tip ends of the bags 52. Each elastic portion 53 is made of a material that has elasticity and has a higher flexibility in shape than the bag 52. Here, a material having a higher flexibility in shape than the bag 52 is a material in which the external force required to cause an equivalent deformation is smaller than the external force required to cause the equivalent deformation in the material constituting the bag 52. The elastic portion 53 may be formed by a bag body and a granular material in the bag body. The granular material may be expanded or non-expanded resin beads. The elastic portion 53 may be a combination of a bag body and a viscous substance in the bag body.

The compressor unit 6 controls the flow of gas into and out of the bags 52 of the cushion 5. In this embodiment, the compressor unit 6 is configured to inject air into and draw air from the bags 52 of the cushion 5. The compressor unit 6 includes a compressor 61, a pipe 62, a connector 63, an air pressure sensor 64, and a controller 65. The compressor 61 is configured to draw air from the outside and pump the air into the bags 52 through the pipe 62. The compressor 61 is further configured to draw air from the bags 52 through the pipe 62 and release the air to the outside. In other words, the compressor 61 is configured to control the internal pressure of the cushion 5.

The pipe 62 is an air passage between the compressor 61 and the cushions 5. The pipe 62 may have branch passages toward the three cushions 5 from the compressor 61. The pipe 62 includes switching valves at branched positions of the pipe 62. Each switching valve is configured to open and close the air passage in the pipe 62 to each cushion 5. Thereby, the switching valve switches the cushion 5 that is the target of internal pressure control by the compressor 61.

The connector 63 is a pipe end that is attached to the wall to which the cushion 5 is attached and to the bottom portion 51 of the cushion 5. The connector 63 includes a joint that fluidly connects the pipe 62 with the inside of the cushion 5. The air pressure sensor 64 may be provided at the joint of the connector 63, and is configured to detect the internal pressure in the cushion 5. The air pressure sensor 64 may be positioned inside the pipe 62.

The controller 65 is mainly composed of at least one dedicated computer, including a computer mounted in the housing 2 in the autonomous transport vehicle 1. The dedicated computer configuring the controller 65 is connected to the drive actuator 31, the sensor system 4, and the compressor 61 through at least one of, for example, a local area network (LAN) line, a wire harness, an internal bus, or a wireless communication line.

The dedicated computer constituting the controller 65 may be a planning Electronic Control Unit (ECU) that plans a target trajectory for the autonomous transport vehicle 1. The dedicated computer constituting the controller 65 may be a trajectory control ECU that causes the actual trajectory of the autonomous transport vehicle 1 to follow the target trajectory. The dedicated computer constituting the controller 65 may be an actuator ECU that controls each drive actuator of the autonomous transport vehicle 1.

The dedicated computer constituting the controller 65 may be a sensing ECU that controls the sensor system 4 of the autonomous transport vehicle 1. The dedicated computer constituting the controller 65 may be a locator ECU that estimates a self-state amount including a self-position of the autonomous transport vehicle 1. The dedicated computer constituting the controller 65 may be an information presentation ECU that controls information presentation system of the autonomous transport vehicle 1. The dedicated computer constituting the controller 65 may be a computer outside the housing 2 that constitutes an external center or a mobile terminal that can communicate via the communication type external sensor 40.

The dedicated computer constituting the controller 65 may include at least one memory 101 and at least one processor 102. The memory 101 is at least one type of non-transitory tangible storage medium, which stores computer readable programs and data in non-transitory manner, such as a semiconductor memory, a magnetic medium, and an optical medium.

Here, the storage may refer to storage where data is retained even when the autonomous transport vehicle 1 is turned off, or it may refer to temporary storage where data is erased when the autonomous transport vehicle 1 is turned off. The processor 102 includes, as a processing core, at least one type of a Central Processing Unit (CPU), a Graphics Processing Unit (GPU), a Reduced Instruction Set Computer (RISC)-CPU, a Data Flow Processor (DFP), and a Graph Streaming Processor (GSP).

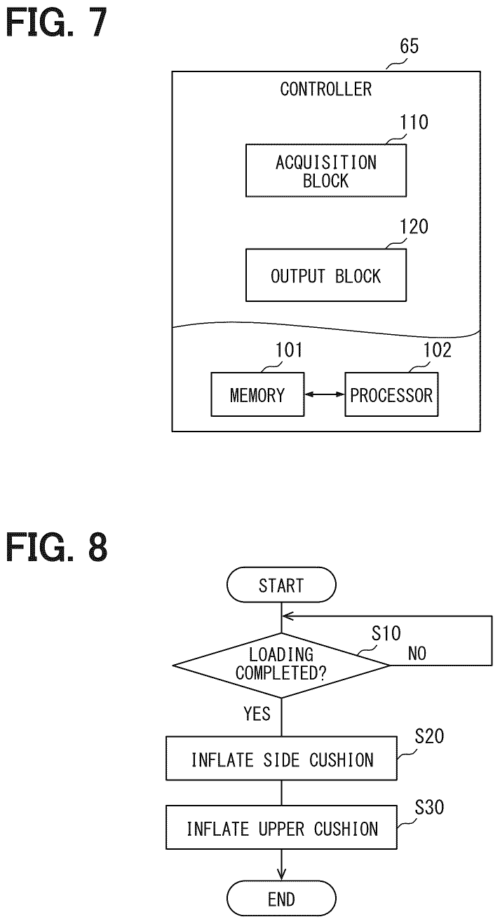

The processor 102 of the controller 65 executes multiple instructions contained in a loading/unloading control program stored in the memory 101 in order to control the loading/unloading process of the package P in the autonomous transport vehicle 1. Thereby, the controller 65 constructs multiple functional blocks for controlling the loading/unloading process of the package P. As shown in FIG. 7, the functional blocks constructed by the controller 65 include an acquisition block 110 and an output block 120.

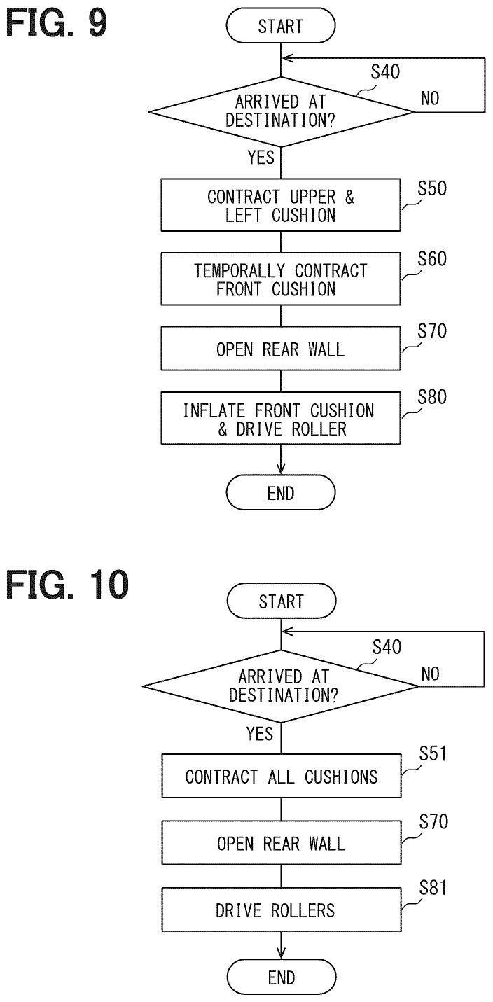

The loading/unloading control method for the controller 65 to control the loading/unloading process of the package P in the autonomous transport vehicle 1 is executed with cooperation of the blocks 110 and 120 according to control flows shown in FIGS. 8 and 9. This control flows are executed while the autonomous transport vehicle 1 is activated. Here, in this flow, “S” means steps of the process executed by instructions included in the loading/unloading control program.

First, the control for loading a package P will be described with reference to the flow of FIG. 8. This flow is executed when the rear wall portion 23 is opened and the loading of a package P starts. In S10, the acquisition block 110 determines whether the loading of the package P has been completed. The acquisition block 110 may determine that the loading of the package P has been completed when information indicating the loading completion is acquired from the outside. When it is determined that the loading has been completed, the flow proceeds to S20.

In S20, the output block 120 controls the compressor unit 6 to inject air into the cushions 5 provided on the side inner walls (i.e., the front inner wall 24a and the left inner wall 25a) and inflates the cushions 5. The output block 120 executes the inflation control until the internal pressure of each cushion 5 reaches a predetermined threshold value. After the inflation has been completed, the flow proceeds to S30. In S30, the output block 120 injects air into the cushion 5 provided on the upper inner wall 21a, and inflates the cushion 5. As in the case of the side inner walls, the output block 120 performs the inflation control until the internal pressure of the cushion 5 reaches a predetermined threshold value. The flow ends after the expansion has been completed.

Next, the control during unloading will be described with reference to the flow of FIG. 9. In S40, the acquisition block 110 determines whether the package P has arrived at its destination. The acquisition block 110 may determine whether the package P has arrived at a pre-recorded destination based on, for example, a positioning signal from the external sensor 40 of a positioning type and map information.

When it is determined that the package P has arrived at the destination, the output block 120 in S50 contracts the cushions 5 provided on the upper inner wall 21a and the left inner wall 25a. The output block 120 outputs a control instruction to the compressor unit 6 to, for example, exhaust substantially all of the air in the cushions 5.

In the next step S60, the output block 120 temporarily contracts the cushion 5 provided on the front inner wall 24a. For example, the output block 120 outputs a control instruction to the compressor unit 6 to draw air until the internal pressure falls within an allowable internal pressure range. The allowable internal pressure range is a range where the pressure of the package P against the rear inner wall 23a by the cushion 5 becomes substantially zero. The allowable internal pressure range is, for example, a range that is smaller than the internal pressure during transportation of the package P and is greater than the internal pressure of each cushion unit 5 provided on the upper inner wall 21a and left inner wall 25a that were contracted in S50.

Then, in S70, the output block 120 opens the rear wall portion 23. Specifically, the output block 120 outputs a control instruction to the actuator that drives the rear wall portion 23, thereby causing the rear wall portion 23 to automatically open.

Thereafter, in S80, the output block 120 inflates the cushion 5 of the front inner wall 24a, and rotates the elastic rollers 27. Specifically, the output block 120 outputs a control instruction to the compressor unit 6 to increase the internal pressure of the cushion 5 to a predetermined value. Then, the output block 120 outputs a control instruction to rotate the elastic rollers 27 in a direction to move the package P to the outside of the housing 2.

According to the first embodiment described above, the autonomous transport vehicle 1 includes the housing 2 that has the inner walls defining the compartment 20 in which a package P is housed. The autonomous transport vehicle 1 has, in the compartment, cushions 5 each having multiple bags 52 between both fixed ends at which the cushion 5 is fixed to the inner wall of the compartment 20 in a reference direction. Each of the multiple bags 52 is configured to inflate with gas from the inner wall. The autonomous transport vehicle 1 includes a compressor unit 6 configured to inject the gas into and draw the gas from the bags 52. Since the multiple bags 52 which are inflated by the compressor unit 6 are disposed between both fixed ends, multiple bags 52 can come into contact with the package P. Thus, the contact area of the cushion 5 with the package P can be relatively large. Therefore, the package P can be properly secured.

Furthermore, according to the first embodiment, the cushion 5 has the elastic portions 53 at the tip ends of the bags 52. Each elastic portion has a higher flexibility in shape than the bags 52. The elastic portion 53 can further increase the contact area with the package P. The elasticity of the elastic portion 53 can press the package P against the inner wall on the opposite side in the inflating direction. This allows the package P to be properly secured.

Furthermore, according to the first embodiment, the housing 2 has an opening through which the package P is put into and removed from the compartment 20, and the rear wall portion 23 configure to open or close the opening. The rear inner wall 23a of the rear wall portion 23 faces upward when the rear wall portion 23 opens the opening. The rear inner wall 23a is provided with an elastic roller 27 that has elasticity and configured to move the package P relative to the compartment 20 by rotating. Thus, the package P can be loaded or unloaded through the opening, which is opened by the rear wall portion 23, by the elastic roller 27. The package P is loaded or unloaded easier using the rear wall portion 23.

Additionally, according to the first embodiment, the cushions 5 are provided on the front inner wall 24a facing the rear wall portion 23 when the rear wall portion 23 closes the opening, the upper inner wall 21a that defines the upper limit of the compartment 20, and the side inner wall adjacent to the front inner wall 24a. According to this, the bags 52 inflate from three of the inner walls that define the compartment 20. The inflation of the bags 52 from the three surfaces can more securely fix the package P.

The compressor unit 6 is configured to reduce the internal pressure before the package P is removed from the compartment 20 from the internal pressure during transportation of the package P, and inject the gas into the cushion 5 on the front inner wall 24a after the rear wall portion 23 is opened to remove the package P from the compartment 20. Thus, the package P is pushed toward the rear wall portion 23 by the cushion 5 on the front inner wall 24a when the package P is removed. Therefore, the package P can be unloaded using the cushion 5.

### Second Embodiment

As shown in FIG. 10, a second embodiment is a modification of the first embodiment. The autonomous transport vehicle 1 in the second embodiment differs from the first embodiment in the control in removing the package P.

The control in removing the package P in the second embodiment will be described with reference to the flow of FIG. 10. First, step S40 is substantially the same process as the step of the same reference numeral in FIG. 9.

When it is determined in S40 that the package P has arrived at the destination, the output block 120 in S51 contracts the cushions 5 provided on the upper inner wall 21a, the left inner wall 25a, and the front inner wall 24a. The output block 120 outputs a control instruction to the compressor unit 6 to draw air until substantially all of the air in the cushions 5 is discharged.

In S70 following S51, the output block 120 opens the rear wall portion 23. Similar to the process flow of FIG. 9, the output block 120 outputs a control instruction to the actuator that drives the rear wall portion 23, thereby causing the rear wall portion 23 to automatically open.

Thereafter, in S81, the output block 120 rotates the elastic rollers 27. Specifically, the output block 120 outputs a control instruction to rotate the elastic rollers 27 in a direction to move the package P to the outside of the housing 2.

According to the above second embodiment, the autonomous transport vehicle 1 is able to remove the package P by driving the elastic rollers 27 without using the cushion 5 provided on the front inner wall 24a to push the package P out.

### Third Embodiment

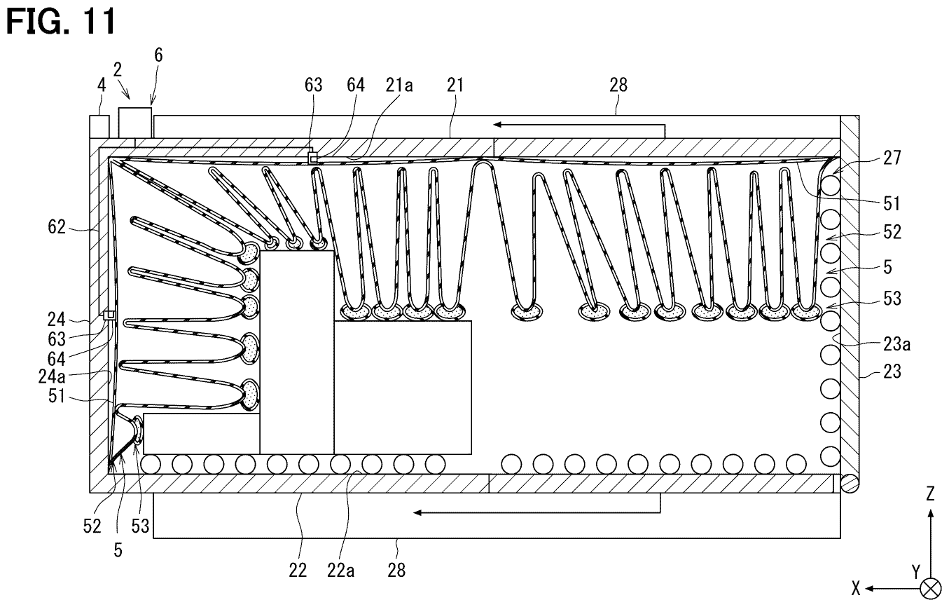

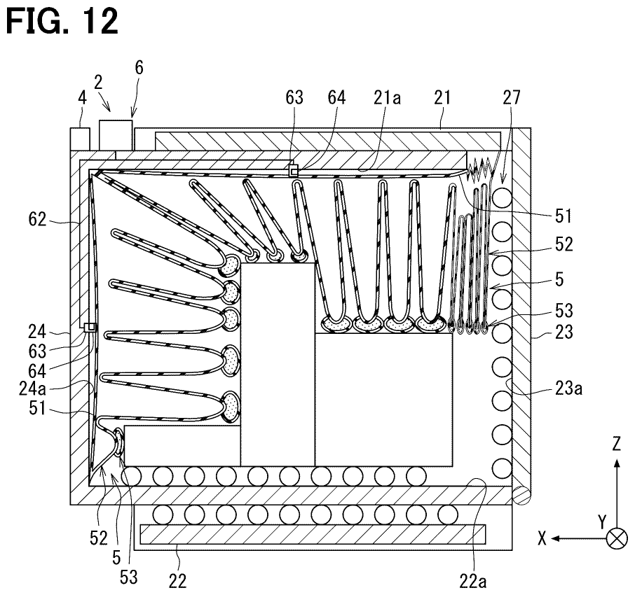

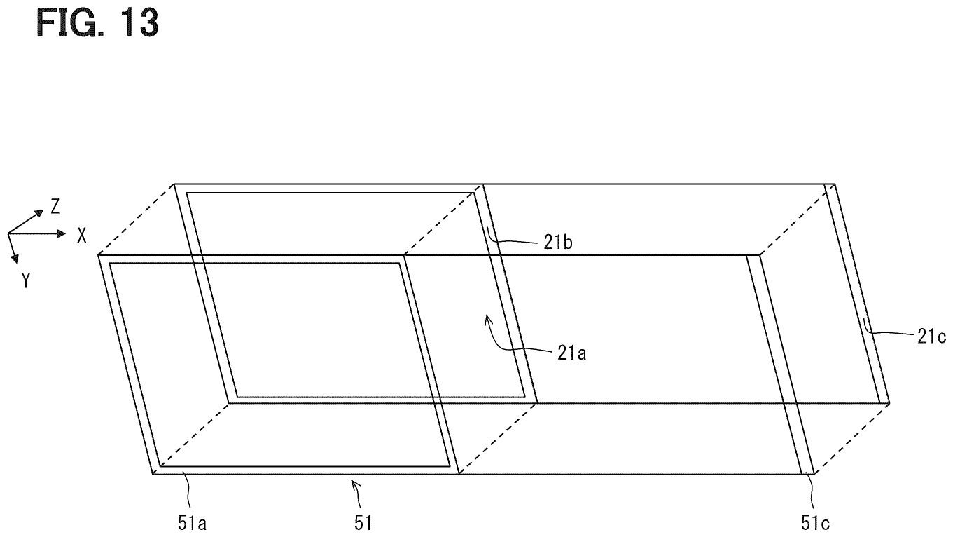

A third embodiment shown in FIGS. 11 and 12 is a modification of the first embodiment.

In the third embodiment, each of the upper wall portion 21, the right wall portion 26, the left wall portion 25 and the lower wall portion 22 of the housing 2 is divided in the front-rear direction into a front portion and a rear portion. The rear portion is an expansion wall that is moved by a size-changing portion 28, which will be described later. The front portion is a fixed wall that is fixed to the housing 2.

The housing 2 has the size-changing portion 28. The size-changing portion 28 includes, for example, an expansion frame and an actuator. The expansion frame allows each expansion wall to move forward. The expansion frame itself can be expand and contract. The actuator is configured to drive the expansion frame to move the expansion walls and inflate or contract the expansion frame. The actuator may be driven in response to control instructions from the controller 65. The size-changing portion 28 expands and contracts depending on the occupancy rate of the package P to be loaded in the compartment 20. This allows the overall size of the housing 2 to be changed depending on the amount or the size of the package P. That is, the housing 2 is switchable between an expanded state shown in FIG. 11 and a contracted state shown in FIG. 12.

In the housing 2, the cushion 5 provided on the upper inner wall 21a is fixed to the expansion wall only at the rear end 51c of the bottom portion 51. Specifically, the rear end 51c of the bottom portion 51 is fixed to the rear end 21c of the upper inner wall 21a. Thus, the cushion 5 on the upper inner wall 21a does not interfere with the contraction of the housing 2. In this case, the rear end 51c also serves as a “fixed portion.” The cushion 5 also has the attachment portion 51a in the bottom portion 51, and the attachment portion 51a is fixed to the inner wall edge 21b of the fixed wall. Similarly, the cushion 5 provided on the left inner wall 25a is fixed to the expansion wall only at a rear end. Specifically, the rear end of the cushion 5 is fixed to the rear end of the left inner wall 25a.

### Fourth Embodiment

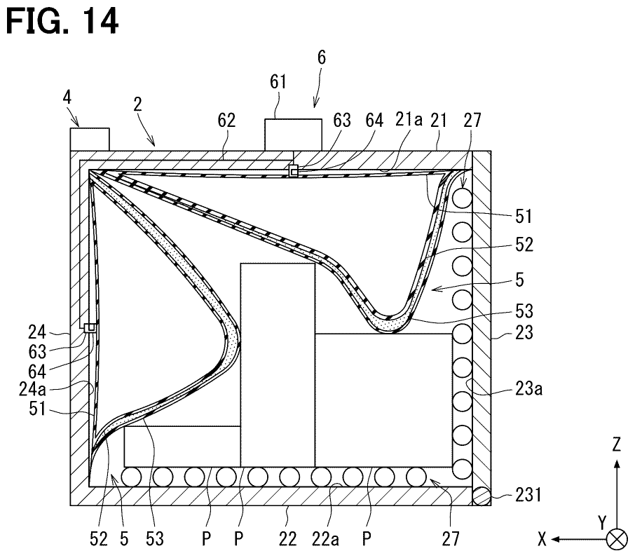

A fourth embodiment shown in FIG. 14 is a modification of the first embodiment.

Each cushion 5 in the fourth embodiment has a single bag 52. An elastic portion 53 is provided at the tip end of the bag 52. The package P can be securely fixed by the elastic portion 53 of the cushion 5 even the cushion 5 has a single bag 52. That is, even when only one bag 52 is formed between the fixed portions to the inner wall, the cushion 5 can reliably fix the package P as long as the elastic portion 53 is provided on the cushion 5.

### Other Embodiments

Although a plurality of embodiments has been described above, the present disclosure is not to be construed as being limited to these embodiments, and can be applied to various embodiments and combinations within a scope not deviating from the gist of the present disclosure.

As a modified example, the cushion 5 does not need to have the elastic portion 53 as long as multiple bags 52 are formed between the fixed portions at which the cushion 5 is fixed to the inner wall.

As a modified example, the cushion 5 may have multiple bags 52 between the fixed portions in only one direction.

As a modified example, the cushion 5 may not have the bottom portion 51, and the outer edge of the bags 52 may be attached to the inner wall. In this case, the cushion 5 may be attached so that the entire outer edge of each bag 52 is in close contact with the inner wall to seal the inner space of the cushion 5.

As a modified example, the cushion 5 may be formed so that internal spaces of the bags 52 are partitioned from each other. Alternatively, the cushion 5 may be formed so that internal spaces of groups, each consisting of several bags 52, are partitioned from each other.

The dedicated computer constituting the controller 65 may include at least one of a digital circuit or an analog circuit as a processor. In particular, the digital circuit is at least one type of, for example, an ASIC (Application Specific Integrated Circuit), a FPGA (Field Programmable Gate Array), an SOC (System on a Chip), a PGA (Programmable Gate Array), a CPLD (Complex Programmable Logic Device), and the like. The digital circuit may include a memory storing a program.

In addition to the above description, the embodiments and modified examples of this disclosure may be implemented in the form of a processing circuit or a semiconductor device as a controller that is configured to be mounted in the autonomous transport vehicle 1 and includes at least one processor 102 and at least one memory 101. The processing circuit is, for example, a processing ECU. The semiconductor device is, for example, a semiconductor chip.

1. An autonomous transport vehicle configured to transport a package, the autonomous transport vehicle comprising:
a housing having an inner wall that defines a compartment in which the package is housed;
a cushion having at least two fixed portions in a reference direction and fixed to the inner wall in the compartment at the at least two fixed portions, the cushion including multiple bags between the at least two fixed portions in the reference direction, each of the multiple bags being configured to inflate from the inner wall with gas; and
a compressor configured to inject the gas into the multiple bags and draw the gas from the bags.

2. The autonomous transport vehicle according to claim 1, wherein
the cushion includes elastic portions at tip ends of the bags, and
the elastic portions has greater flexibility in shape than the multiple bags.

3. An autonomous transport vehicle configured to transport a package, the autonomous transport vehicle comprising:
a housing having an inner wall that defines a compartment in which the package is housed;
a cushion fixed to the inner wall in the compartment, and having:
a bag configured to inflate with gas from the inner wall; and
an elastic portion at a tip end of the bag; and
a compressor configured to inject the gas into the bag and draw the gas from the bag.

4. The autonomous transport vehicle according to claim 1, wherein
the housing defines an opening through which the package is put into or removed from the compartment, and includes a door configured to open and close the opening,
the door has a door inner wall constituting a part of the inner wall and the door inner wall faces upward when the door is open, and
the door inner wall is provided with an elastic roller that is configured to move the package by rotating.

5. The autonomous transport vehicle according to claim 4, wherein
the inner wall further includes:
a door facing inner wall that faces the door when the door is closed;
an upper inner wall of the compartment; and
a side inner wall of the compartment,
the cushion is one of cushions, and
the cushions are provided on the door facing inner wall, the upper inner wall, and the side inner wall.

6. The autonomous transport vehicle according to claim 5, wherein
the compressor is configured to inject the gas into the cushions provided on the door facing inner wall and the side inner wall, and then inject the gas into the cushion provided on the upper inner wall.

7. The autonomous transport vehicle according to claim 6, wherein
the compressor is configured to inject the gas into the cushion provided on the upper inner wall after the package is put into the compartment and the door is closed.

8. The autonomous transport vehicle according to claim 5, wherein
the compressor is configured to:
reduce an inner pressure of the cushion provided on the door facing inner wall prior to removing the package from the compartment; and
inject the gas into the cushion provided on the door facing inner wall when the door is open to remove the package from the compartment.

9. The autonomous transport vehicle according to claim 1, wherein
the housing includes a size-changing portion configured to change the compartment in size by expanding or contracting according to a size of the package.
